(19) United States
(12) Patent Application Publication
(10) Pub. No.: US 2016/0006531 A1
(43) Pub. Date: Jan. 7, 2016

(54) METHODS AND APPARATUS FOR IMPROVING SERVICE SEARCH AND BAND SCAN

(71) Applicant: QUALCOMM Incorporated, San Diego, CA (US)

(72) Inventors: Dinesh KUMAR, Hyderabad (IN); Anand Venkata Ratna GANGIREDLA, Hyderabad (IN); Praveen Nagaraja KONA, Hyderabad (IN); Chintan Shirish SHAH, San Diego, CA (US); Seyed Ali AHMADZADEH, San Diego, CA (US)

(21) Appl. No.: 14/323,404

(22) Filed: Jul. 3, 2014

(51) Int. Cl. H04J 11/00; H04W 8/02

(52) U.S. Cl. CPC H04J 11/0086; H04J 11/0093; H04W 8/02; H04W 88/06

(57) ABSTRACT

Certain aspects of the present disclosure relate to techniques for improving band scanning procedures by a UE, for example, to speed re-acquiring service after a loss of service event.

### FIELD

The present disclosure relates generally to communication systems, and more particularly, to methods and apparatus for improving service search and band scans.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology.

However, as the demand for mobile broadband access continues to increase, there exists a need for further improvements in LTE technology. One such need is for improvement in the amount it takes a device to scan for service, for example, after experiencing a loss of service in a serving cell.

### SUMMARY

Certain aspects of the present disclosure provide techniques and apparatus for enhanced scanning by a user equipment (UE).

Certain aspects provide a method for wireless communication by an apparatus. The method generally includes detecting a loss in service in a first cell, performing a band scan of bands supported by the apparatus to attempt to acquire service, and interleaving, based on a predetermined time period or a number of bands scanned during the band scan, a priority-based scan of a limited number of one or more frequencies while performing the band scan.

Certain aspects provide a method for wireless communication by an apparatus. The method generally includes storing information related to one or more loss of service events, detecting a loss in service in a first cell, and performing a priority-based scan of one or more frequencies, determined using the stored information, to attempt to acquire service.

Aspects generally include methods, apparatus, systems, computer program products, and processing systems, as substantially described herein with reference to and as illustrated by the accompanying drawings.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 illustrates example operations that may performed, for example, by a UE, to search for service.

FIG. 8 illustrates example durations of band scans that may be performed by a UE.

FIG. 9 illustrates example operations that may be performed, for example, by a UE, to perform an improved band scan in accordance with aspects of the present disclosure.

FIGS. 10 and 10A illustrate an example of an improved band scan, in accordance with aspects of the present disclosure.

FIGS. 11 and 11A illustrate another example of an improved band scan, in accordance with aspects of the present disclosure.

FIG. 12 illustrates example operations that may performed, for example, by a UE, to perform an improved out of service search in accordance with aspects of the present disclosure.

FIG. 13 illustrates an example radio link failure (RLF) database entry, in accordance with aspects of the present disclosure.

### DETAILED DESCRIPTION

Aspects of the present disclosure provide techniques that may help enhance UE scanning procedures when looking for service, for example, after a loss of service event.

According to one technique, a UE may perform a scanning procedure where a priority-based scan (e.g., of a limited number of frequencies) is interleaved with a full band scan. In scenarios where service was lost temporarily (e.g., due to mobility of the UE through a location with weak or no service, the technique may help ensure the UE reacquire the lost service quickly (e.g., without waiting for the full band scan to complete).

According to another technique, a UE may store information related to loss of service events. If a subsequent loss of service event matches a previously loss of service event, the stored information may be used to perform a priority priority-based scan, which may also help ensure the UE reacquire the lost service quickly.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software/firmware, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software/firmware, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

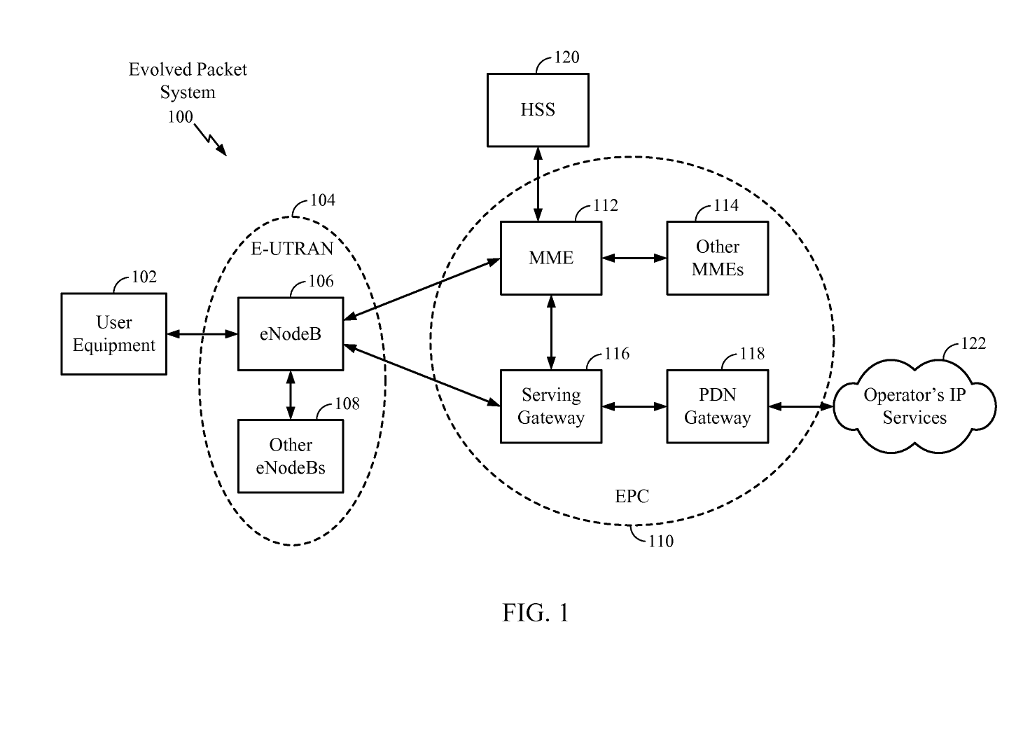

FIG. 1 is a diagram illustrating an LTE network architecture 100, in which one or more UEs 102 may perform enhanced scanning operations, in accordance aspects of the present disclosure.

The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS Streaming Service (PSS). In this manner, the UE102 may be coupled to the PDN through the LTE network.

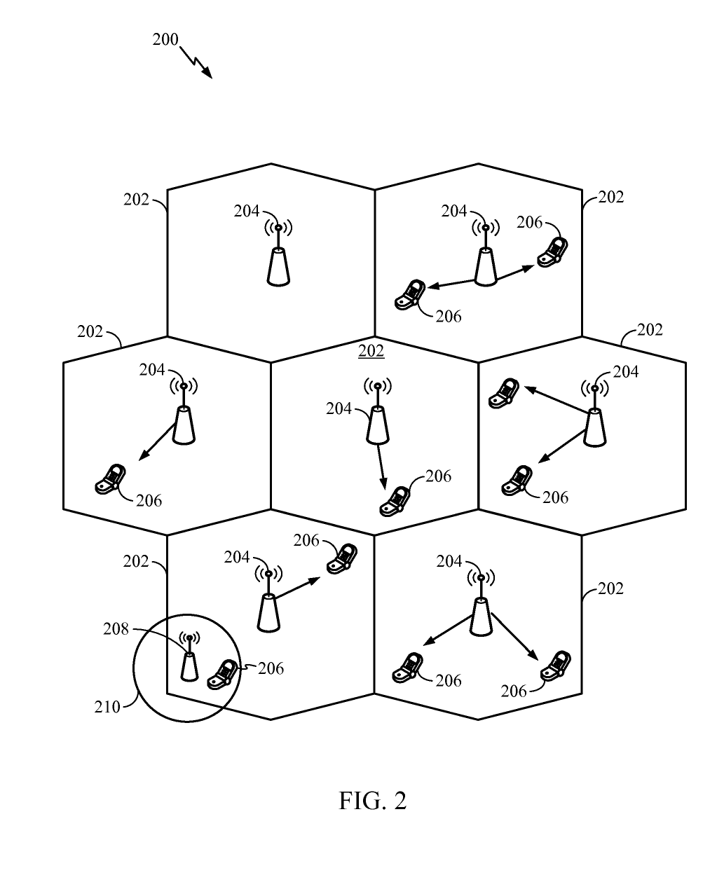

FIG. 2 is a diagram illustrating an example of an access network 200 in an LTE network architecture. In this example, the access network 200 is divided into a number of cellular regions (e.g., cells) 202. As will be described in detail below, UEs 206 may perform techniques described herein to search for and obtain service from the different cells 202.

One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

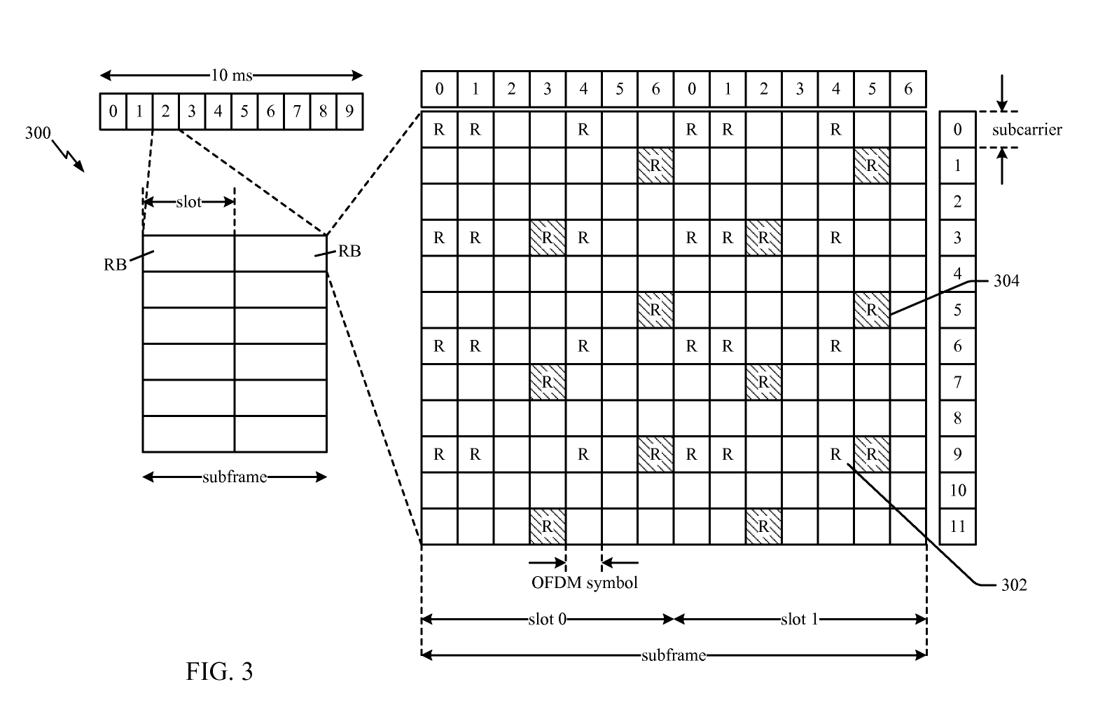

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. In fact, these synchronization signals may be detected by a UE when performing the various enhanced scanning operations described herein.

The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

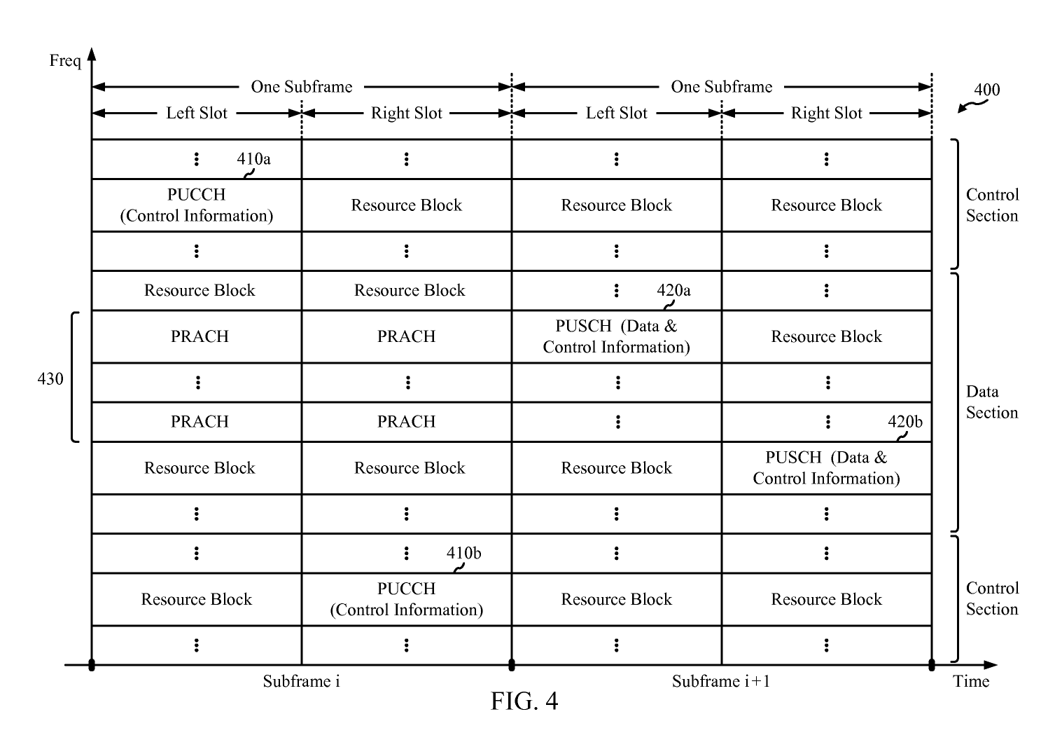

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

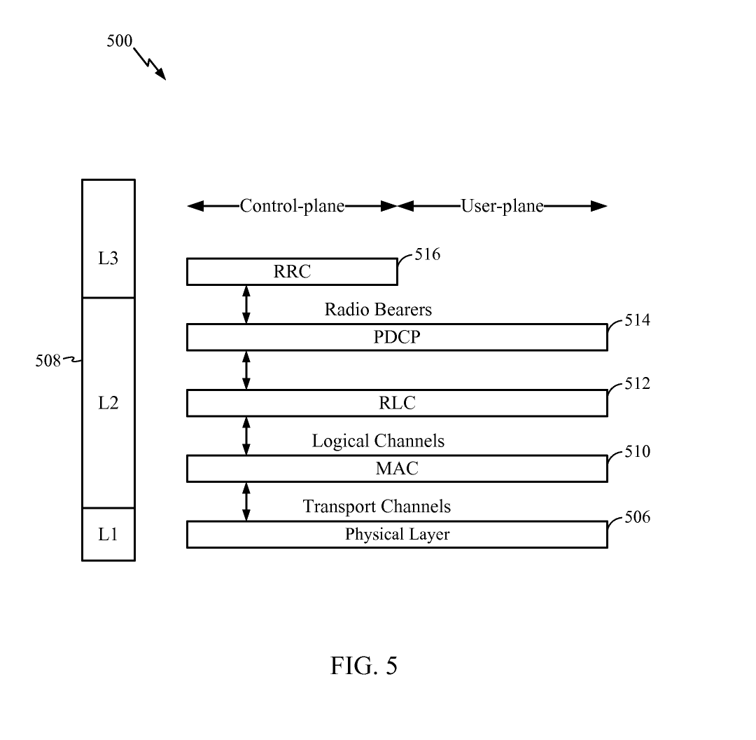

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

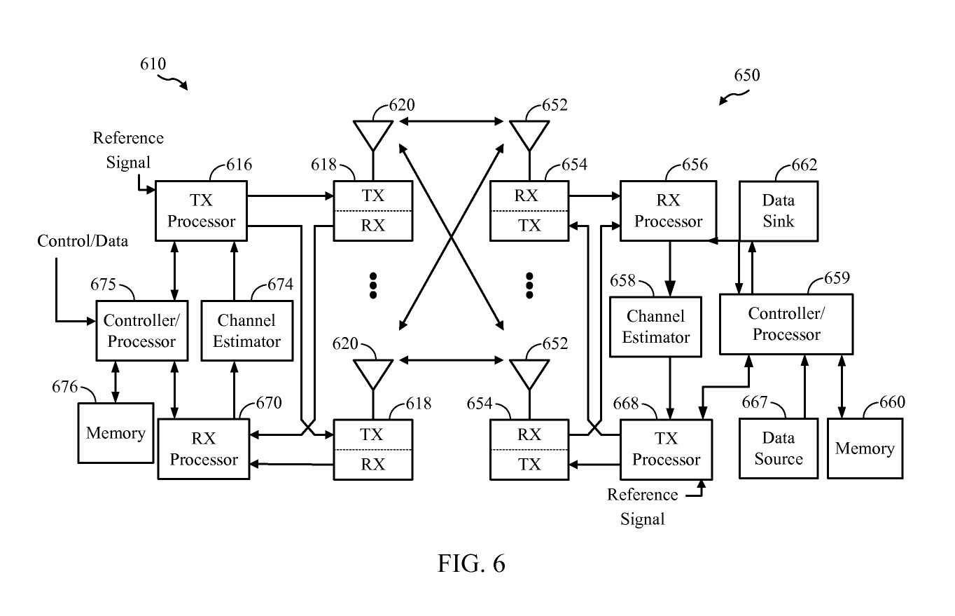

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

In some cases, RX processor 656 and/or controller/processor 659 of UE 650 may be configured to perform various operations of the enhanced scanning procedures described herein.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. In aspects, any one of the controller/processor 659, RX processor 656, and TX processor 668, memory 660 or a combination thereof of the UE 650 may be configured to perform the improved search and band scan methods discussed below. In an aspect, at least one of the controller/processor 659, RX processor 656, and TX processor 668 may be configured to execute algorithms stored in a memory 660 for performing the improved search and band scan methods.

### Example Improved Service Search and Band Scan

When a UE that supports multimode bands (e.g., both FDD & TDD) encounters a loss of service event, such as a Radio Link Failure (RLF), in a serving LTE system, it performs a band scanning procedure (e.g., searching different frequencies for synchronization signals) in order gain service (e.g., LTE service).

Current procedures performed by a UE to scan supported bands in a search for service may be less than optimal. For example, under current implementations, a UE that performs an RLF on a serving LTE system may scan the lost LTE cell for a period of 200 ms, then (if no service is acquired) perform a complete Band Scan (scanning all bands it supports), which may take a significant amount of time to complete. Finally, if no service is acquired still, the UE may again scan the source LTE system on which the loss of service occurred.

A UE may encounter a sudden (and temporary) RLF due to a sudden loss of LTE service due to various environmental scenarios (e.g., in areas of little or no coverage, such as so-called deep basement areas or elevator movement) and start scanning the LTE bands.

Some algorithms may allow a UE to give priority to certain frequencies (e.g., or bands), such as those associated with previously acquired cells and stored in an acquisition database (Acq DB).

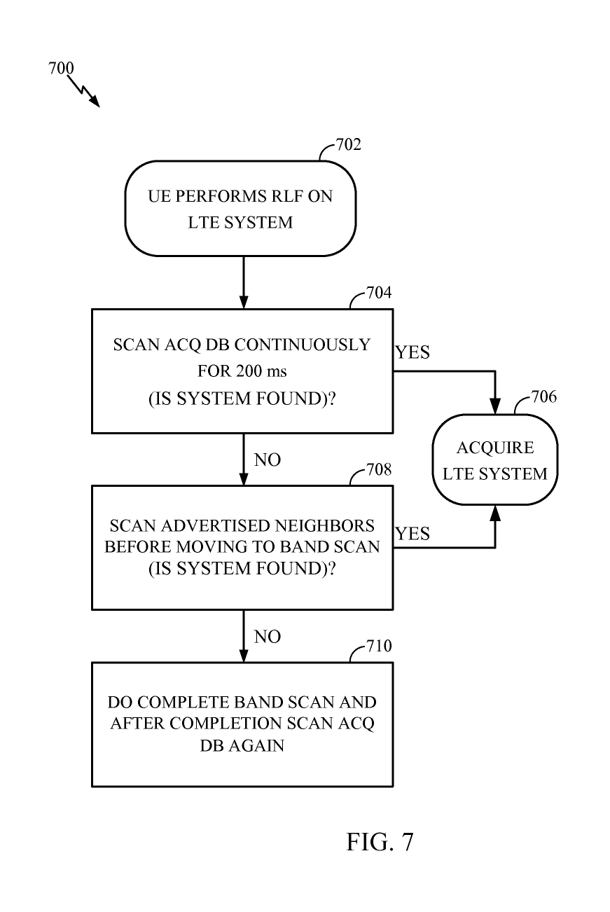

FIG. 7 illustrates example operations 700 for one such algorithm. After performing an RLF on an LTE system, at 702, a UE may scan frequencies identified in an Acq DB for a period of time (e.g., scanning continuously for a 200 ms window), at 704. If the system is found, the UE acquires the LTE system, at 706. Otherwise, at 708, the UE proceeds to scan advertised neighbors (e.g., listed in a reconfig message), before performing a full band scan, at 710, before giving the Acq DB another try (e.g., right before T311 expiry).

With these algorithms, however, if the UE fails to find the system within the first 200 ms after performing the RLF, it may again scan all the bands it supports, resulting in substantial delay. Thus, the UE may be required to wait a long time with no service even though the RLF happened due to absence for LTE service for the scenario mentioned above and the cell in which the loss of service occurred may soon be available again.

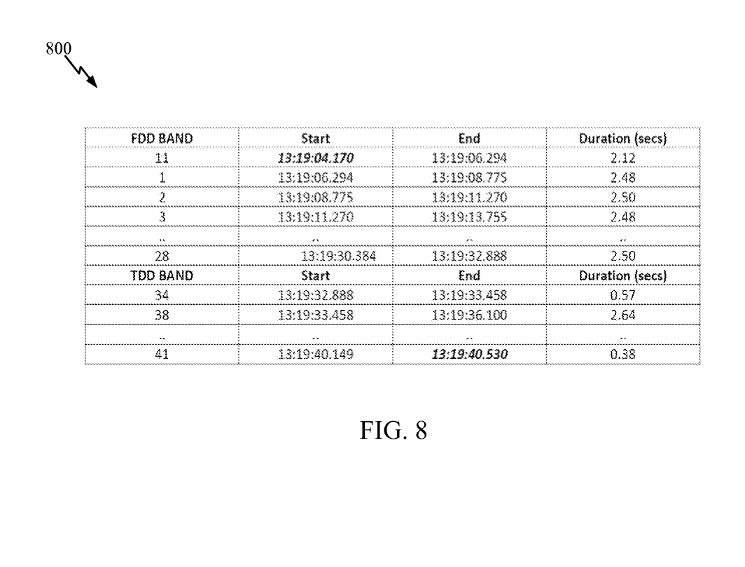

An example of the extent of this wait time may be described with reference to FIG. 8 that illustrates table 800 of example durations of band scans that may be performed by a UE. As illustrated, the UE may begin a full band scan with LTE FDD band 11 (e.g., at a start time of 13:19:04.170). The UE may sequentially scan each band until finally completing scanning of the last band LTE TDD band 41 (e.g., at an end time of 13:19:40.530). Based on these example start and end times, a full band scan takes 36.36 seconds.

By recognizing that the cell on which the RLF occurred may have become available early on in this full band scan cycle, aspects of the present disclosure propose interleaving a priority-based scanning procedure with a full band scan. The proposed techniques may help a UE re-acquire a lost LTE system much quicker (e.g., within ˜15 secs) relative to the duration of the full band scan. As a result, a UE implementing the techniques described herein may be able to run real-time applications utilizing LTE to provide seamless service without any disruption.

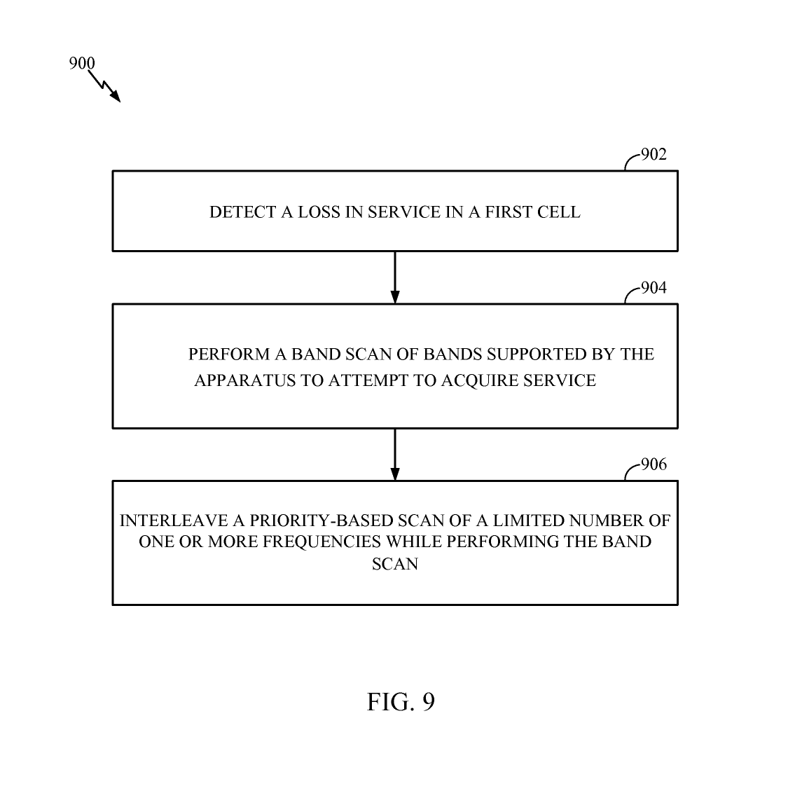

FIG. 9 illustrates example operations 900 that may performed, for example, by a UE, to perform an improved (e.g., optimized) band scan in accordance with aspects of the present disclosure. At 902, the UE detects a loss in service in a first cell. At 904, the UE performs a band scan of bands supported by the apparatus to attempt to acquire service. At 906, the UE interleaves, based on a predetermined time period or a number of bands scanned during the band scan, a priority-based scan of a limited number of one or more frequencies while performing the band scan.

Performing the priority-based scan (e.g., of the Acq DB) more often may allow a UE to detect cases when service becomes available early in the full band scan, which may help ensure the UE reacquires the lost LTE system quickly. The present disclosure provides various techniques that may be used for interleaving a priority-based scan of a limited number of one or more frequencies while performing the band scan.

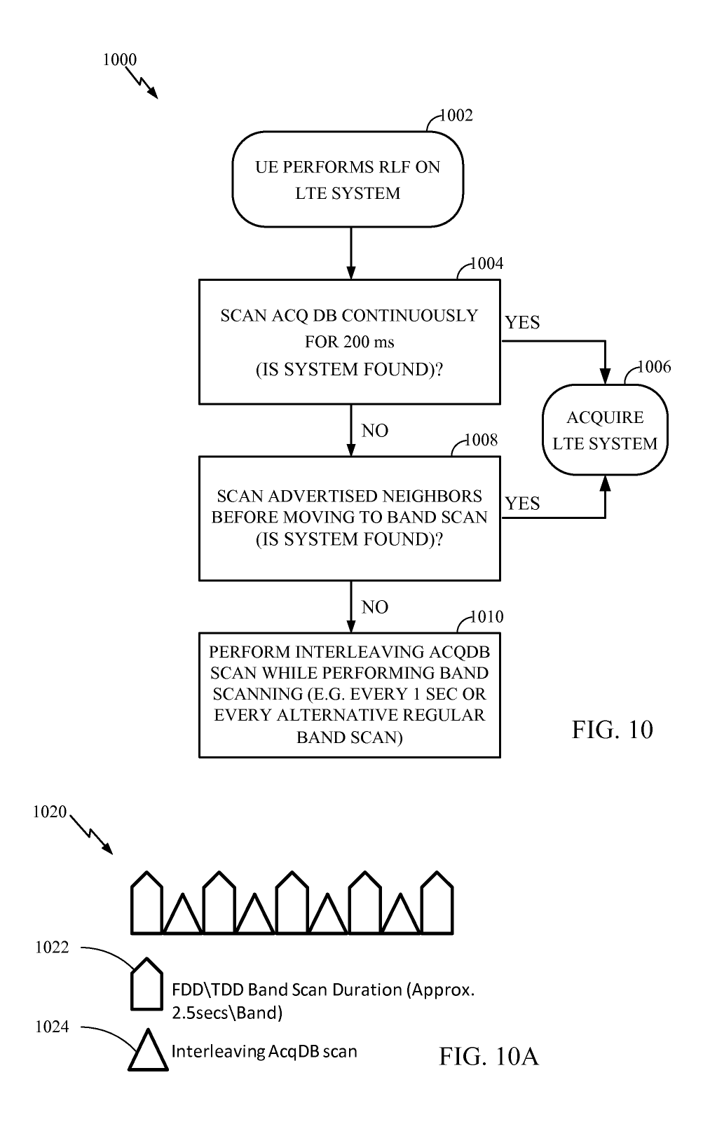

For example, FIG. 10 illustrates example operations 1000 in which a UE may periodically perform a priority-based scan during the full band scan (e.g., every second or every alternative band scan) in accordance with aspects. As illustrated, operations 1002-1008 may be the same as operations 702-708 described above, with reference to FIG. 7.

If no service is found after scanning the Acq DB (at 1004) and advertised neighbors (at 1008), the UE may perform interleaving of the Acq DB scan while performing a full band scan, at 1010. The Acq DB scan may be performed (e.g., searching for an EARFCN where the loss of service occurred), for example, periodically (e.g., every 1 sec). As an alternative, the Acq DB scan may be performed after every alternative scanned band. In either case, this may result in a high probability that the lost system can be reacquired quickly.

FIG. 10A illustrates graphically, via a timing diagram 1020, the scenario where the Acq DB scan may be performed after every alternative Band scan in accordance with aspects. As illustrated, an Acq DB scan 1024 is performed between band scans 1022. Given the values in table 800 of FIG. 8, each band scan may take approximately 2.5 seconds, on average, per band.

In some cases, a priority-based scan may be performed on a band in which service was lost. In other words, the UE may scan the “lost band” where the loss of service event (e.g., RLF) occurred, for example, every T_{band} period, during the full band scan. This approach may also give the UE a higher probability to (re-)acquire the LTE system on the same band from the neighboring cells as well. The period (T_{band}) with which the lost band is scanned may be configurable, for example, according to an optimization requirement (e.g., allowing a scan of the interleaving band to be performed every 2, 3 or 4 band intervals).

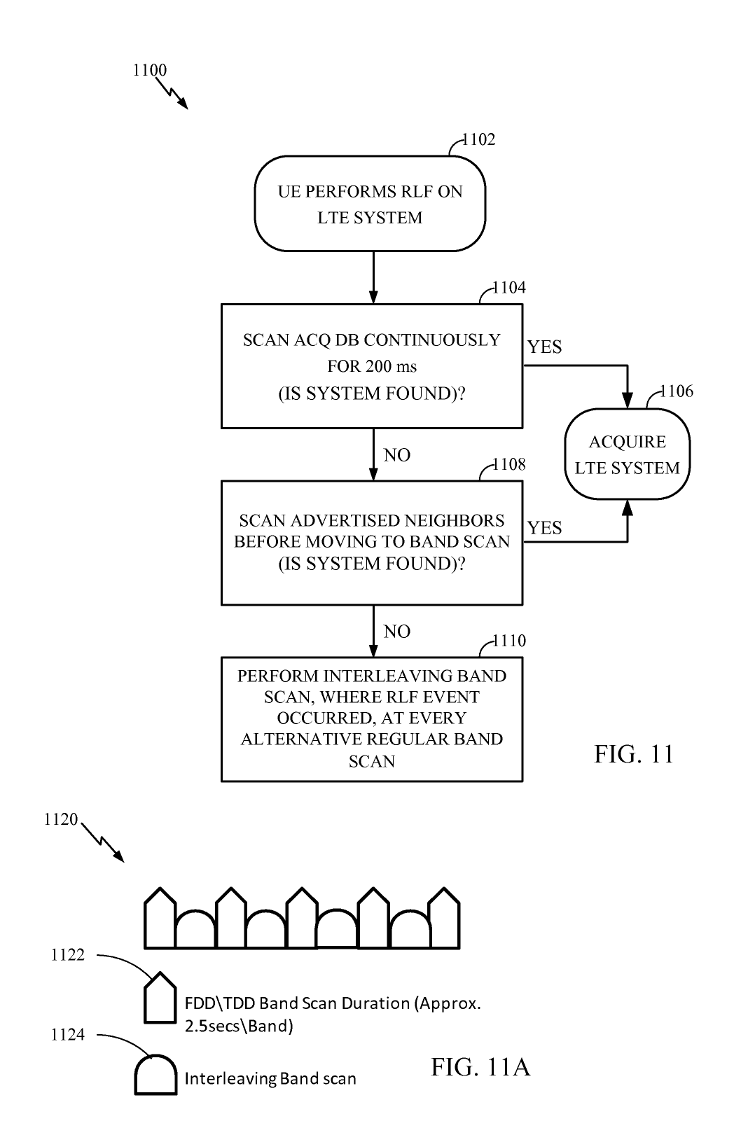

FIG. 11 illustrates example operations 1100 in which a UE may periodically perform a priority-based scan of a “lost band” during the full band scan (e.g., every second or every alternative band scan) in accordance with aspects. As illustrated, operations 1102-1108 may be the same as operations 702-708 described above, with reference to FIG. 7.

If no service is found after scanning the Acq DB (at 1104) and advertised neighbors (at 1108), the UE may perform interleaving of the band scan where the RLF event occurred while performing a full band scan, at 1110.

FIG. 11A illustrates graphically, via a timing diagram 1120, the scenario where the interleaving (lost) band scan 1124 is performed after each alternative Band scan 1122 in accordance with aspects. As noted above, the lost band scan may allow the UE to scan the cell where the loss of service occurred, as well as neighboring cells, which may result in a high probability that the lost system can be reacquired quickly.

In aspects, the Acq DB includes E-UTRA Absolute Radio Frequency Channel Number (EARFCN) values for one or more cells previously camped on by the apparatus. In aspects, interleaving, based on a predetermined time period or a number of bands scanned during the band scan, a priority-based scan of a limited number of one or more frequencies while performing the band scan comprises performing a priority-based scan of one or more frequencies from at least one of an acquisition database (Acq DB) at regular time intervals during the band scan. In aspects, interleaving, based on a predetermined time period or a number of bands scanned during the band scan, a priority-based scan of a limited number of one or more frequencies while performing the band scan comprises alternating between performing a band scan and performing a priority-based scan of one or more frequencies from at least one of an acquisition database (Acq DB). In aspects, interleaving, based on a predetermined time period or a number of bands scanned during the band scan, a priority-based scan of a limited number of one or more frequencies while performing the band scan comprises performing a priority-based scan of a band corresponding to the first cell in which service was lost at regular time intervals during the band scan. In aspects, the regular time intervals correspond to a period of an integer value of a band scan interval.

### Improved Out of Service Search Based on Mobile Device History and Self-Learning

Aspects of the present disclosure may provide techniques that allow a UE to perform enhanced scanning based on “self-learning” by the UE. For example, the UE may be able to store information related to loss of service events and use this information to take advantage of certain usage patterns to re-acquire service sooner than might otherwise be possible.

Conventional out of service (OOS) algorithms seek to first acquire the system/Radio Access Technology (RAT) on which the system lost event occurred. As noted above, in doing so, the UE will typically perform a full band scan, searching all the bands and frequencies associated and provisioned for the given RAT. This process is usually expensive in terms of power (e.g., current consumption).

For example, scanning 4 LTE bands in some networks may take more than 13 seconds, which will consume considerable power. This approach is also sub-optimal, in that (as noted above) if a usable frequency is that the end of the band scan (example lost ARFCN is the last, (e.g., 4th LTE band), the UE still scans the other 3 bands. If the UE fails to find service, even after extensive band scans, the UE may begin to look for roaming systems. This contributes to poor user experience for those users who may have to wait a long period of time to get service.

Current algorithms also have limitations in that they do not have any notion or information about the UE geographic location or the UE's relative location (e.g., relative to network deployment and cells). Aspects of the present disclosure, may take advantage of the observation that certain system loss events occur based on a pattern. This may be seen, as most people (users) have a pattern defined to their regular lives. For example, most people follow the same route between their home and work place. Even in indoor scenarios like parking structures, people tend to park in the same or similar spots and lead the same path to their office location. If the UE experiences a system loss event in such a route/location, it may be expected with a high probability that it will encounter a system loss event in a proximate or same location the next time the UE is in this vicinity of such a location.

Aspects of the present disclosure may take advantage of this repeated use behavior by storing information related to loss of service events. This information may then be used to perform enhanced scanning after subsequent loss of service. Effectively reducing the service search space for the UE based on this information may have many benefits, such as improved (e.g., reduced) service acquisition time, reduced out of service duration, minimized effect of radio link failure, and/or reduced power consumption, all of which may result in better overall user experience.

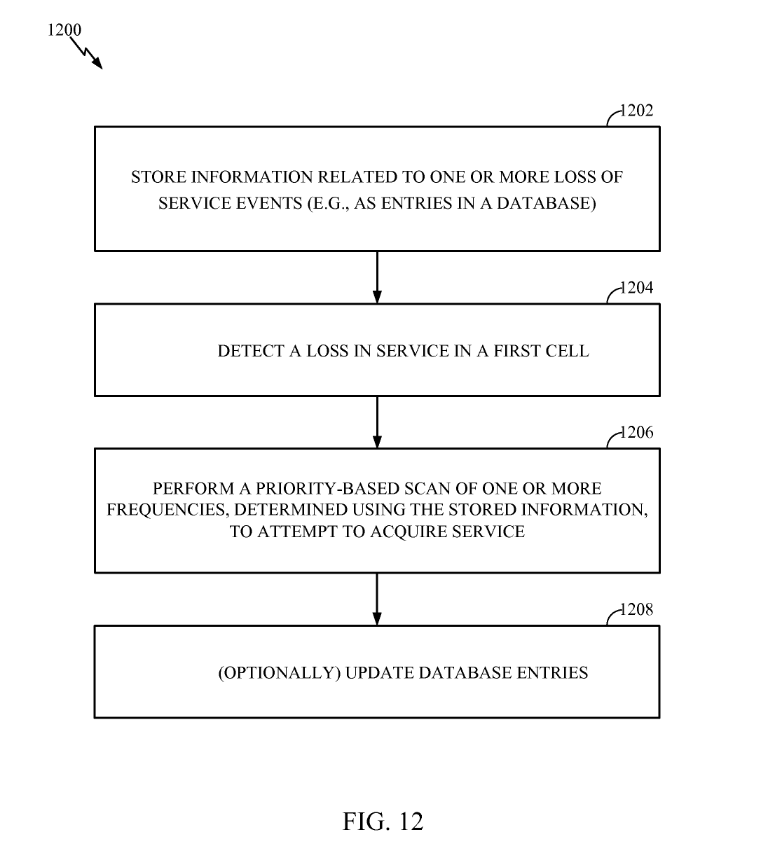

FIG. 12 illustrates example operations 1200 that may performed, for example, by a UE, to perform an improved (e.g., optimized) band scan in accordance with aspects of the present disclosure. At 1202, the UE stores information related to one or more loss of service events. At 1204, the UE detects a loss in service in a first cell. At 1206, the UE performs a priority-based scan of one or more frequencies, determined using the stored information, to attempt to acquire service.

This technique may recognize that user behavior, and therefore, their UE, usually follows a pattern, for example, with the user often traveling a similar path and visiting the same cells. The behavior may also happen repeatedly at the similar time periods. Thus, useful information may be stored about loss of service (e.g., RLF and OOS) events that happen frequently. For example, OOS due to deployment issues are typically limited to specific areas. Using techniques presented herein, a UE may learn about possible OOS and RLF events and react accordingly to perform an enhanced scanning procedure and find service sooner.

In some cases, the techniques presented herein allow the UE to learn from past OOS/RLF events and use the solution (e.g., information regarding a cell on which service was successfully acquired) of each event in case a similar event is observed. In some cases, band scan improvements may be designed for random and less frequent OOS/RLF events. In some cases, information related to loss of service events may be captured and stored in a database (e.g., which may be referred to herein as an RLF database). In other words, the basic idea may be to capture the historical and geographical/relative location information and/or detect patterns to reduce the search space as mentioned above. In aspects, the method 1200 further comprises determining, based on the stored information, that the loss in service is similar to a previous loss of service event and performing the priority-based scan based on stored information from the previous loss of service event. In aspects, the information is stored in a database with entries identified by one or more parameters that identify a cell where a loss of service event occurred. In aspects, the one or more parameters comprise an E-UTRA Absolute Radio Frequency Channel Number (EARFCN), public land mobile network (PLMN) identifier (ID), and a physical cell ID (PCI). In aspects, the method 1200 further comprises identifying an entry for a previous loss of service event on the first cell, based on the EARFCN, PLMN ID, and PCI of the first cell. In aspects, each entry for a cell includes information regarding at least one of a frequency at which a loss of service event occurred, a number of times the loss of service event occurred, apparatus mobility information, or a time of a last occurrence of the loss of service event. In aspects, each entry for a cell includes information regarding a second cell on which service was acquired following the loss of service event. In aspects, the information regarding a second cell on which service was acquired following the loss of service event comprises an E-UTRA Absolute Radio Frequency Channel Number (EARFCN), public land mobile network (PLMN) identifier (ID), and a physical cell ID (PCI) of the cell on which service was acquired following the loss of service event. In aspects, each entry for a cell includes at least one of time spent after the loss of service occurred before acquiring service on the second cell or a success rate for acquiring service on the second cell. In aspects, the method 1200 includes creating an entry in the database for a cell that does not have a matching entry. In aspects, the method 1200 includes removing an entry from the database if a number or entries is at a threshold value. In aspects, removing an entry from the database includes removing an entry from the database based on at least one of a time since a last occurrence of a loss of service, a number of occurrences of loss of service, a number of times service was successfully acquired after performing a priority-based scan using parameters in the entry, or time since a service was last successfully acquired after performing a priority-based scan using parameters in the entry. In aspects, the method 1200 includes updating an entry in the database for a cell if the apparatus detects a loss of service on that cell. In aspects, updating the entry comprises at least one of updating at least one of an occurrence count, a time since a last occurrence of a loss of service event, a number of times service was successfully acquired after performing a priority-based scan using parameters in the entry, or time since a service was last successfully acquired after performing a priority-based scan using parameters in the entry, removing parameters for a cell on which service was successfully acquired after a loss of service event, or adding parameters for a cell on which service was successfully acquired after a loss of service. In aspects, the method 1200 includes storing information related to at least one of solution employed in response to the one or more loss of service events or patterns of apparatus movement. In aspects, the stored information is maintained by the apparatus.

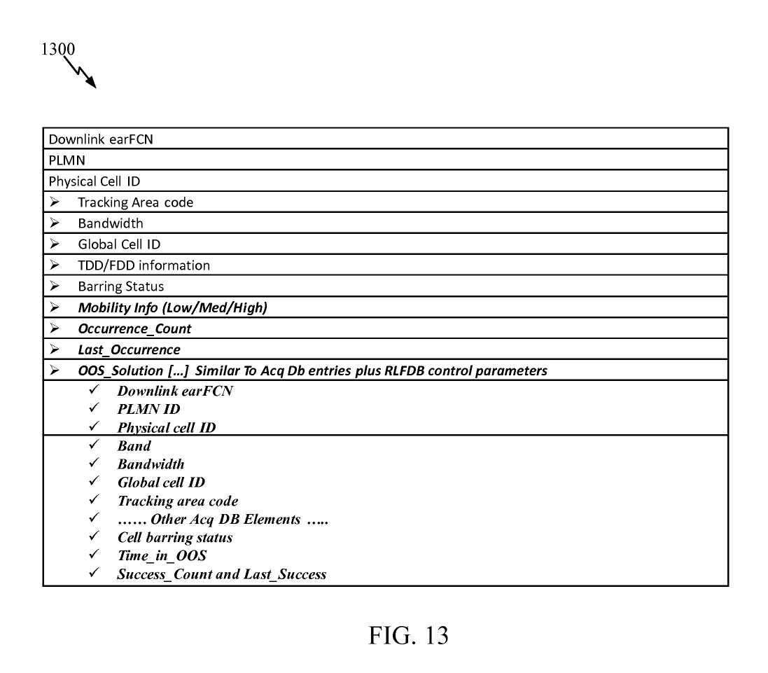

FIG. 13 illustrates the type of information that may be stored in a database entry 1300 for an example loss of service event in accordance with aspects. As illustrated, the loss event may be uniquely identified by a triplet of information indicative of the cell in which it occurred. This triplet of information may include, for example, an E-UTRA Absolute Radio Frequency Channel Number (EARFCN), public land mobile network (PLMN) identifier (ID), and a physical cell ID (PCI). As illustrated, the information stored about the loss event may include mobility information (e.g., was the mobility low, medium, or high at the time of the event), an occurrence count (e.g., number of times or frequency with which the event has occurred), and/or a last occurrence of the event.

As illustrated, information related to a solution (e.g., leading to successful acquisition of service) may be stored. This information may include a similar triplet of information identifying a cell in which service was successfully acquired. In some cases, the information may include an amount of time the UE was out of service before re-acquiring service, a parameter indicative of how successful the solution has been (e.g., a success count), and/or an indication of a last time the solution was a success.

Using such entries as shown in FIG. 13, once a system loss event occurs at a given location and/or time of day, the UE can capture the information on the cell where this event occurs (e.g., information for an LTE cell where a RLF occurred). As described above, this information may be unique to each RAT's cell within a given system. On a first occasion when the UE encounters a system loss on a given RAT, the UE may create an entry record on which cell this event occurred and/or which RAT/system/PLMN the UE eventually camped on after the loss of service.

Upon any subsequent system loss event on the same cell (e.g., as identified by the unique set of triplet information), the UE can first look into the RLF DB to find which RAT it had acquired on such a previous system loss event and use this information in a priority-based scan. For example, The UE can then look at the particular ARFCN specified in the RLF DB on the particular PLMN and RAT which is also specified in the RLF DB and perform a focused search using this information. Such a “directed” search will not only save time in restoring service to the end user but will also save power

As described above, the RLF DB also incorporates a notion of time since the system loss event that the particular ARFCN on a particular PLMN_RAT was acquired. Thus, the UE can continue with its current design of OOS and the UE (e.g., software) can perform the “directed search” at the appropriate time which, for example, will be proportional to the filtered time delay (e.g., and delay from the system loss event to successful acquisition on the given ARFCN) when such an ARFCN was acquired upon the previous system loss event. Such a time delay may be critical in that it may be desirable to prevent the UE from searching for a system when the probability of its existence in the deployment is low. It is more desirable to perform this search when the probability of its existence in the deployment is high.

In some cases, the RLF DB may provide for weighting the “success entries.” For example, this information may indicate those RAT/PLMN/ARFCNs that are more successful and a UE may give these preference. Such a hybrid approach to searching, where the UE is permitted to follow its current OOS design, but is enhanced with directed searches, may lead to a more effective OOS approach, wherein time to service and/or current consumption are reduced.

As described herein, the RLF DB may include information about previous OOS/RLF events that may be used to limit the search space for acquisition algorithm when similar events happen again. Each entry in the RLF DB is identified by a unique serving triplet (EARFCN, PLMN ID, PCI), which may be used to identify similar RLF/OOS events. In some cases, a number of entries in the RLF DB may be limited (e.g., to 10 entries or so as with an Acq DB) and entries may need to be removed when new ones are created.

In some cases, RLF DB entries may be included/maintained (e.g., by the UE) based on one or more conditions. For example, a UE may declare an RLF/OOS on a serving cell that does not have a matching serving triplet (PCI, EARFCN, PLMN) in the RLF DB. An example RLF DB solution inclusion condition may be, for example, that the serving triplet (PCI, EARFCN, PLMN) corresponding to the current serving cell exists in the table (e.g., it can be just added due to current RLF/OOS incident), the RRC declares OOS/RLF while camped on the serving cell, and a solution is found by the UE that passes a certain test. For example, the test for the solution may be that service has been acquired, that SIBs (e.g., MIB, SIB1 and SIB2) have been successfully read, that it has passed the cell barring check, and that time in OOS does not exceed the predefined upper bound (e.g., 5 minutes). An entry may not be added, for example, if the time in OOS exceeds the upper bound.

Entries in the RLF DB may be updated based on certain conditions. For example, the conditions may be that the UE declares RLF/OOS on a serving cell that matches a serving triplet (PCI, EARFCN, PLMN) in the RLF DB and updates Mobility_info, Occurrence_Count, and Last_Occurrence elements. Solution information for an entry may also be updated if the UE finds a solution after declaring OOS/RLF while camped on a serving cell that matches a serving triplet in the RLF DB and the solution triplet (PCI, EARFCN, PLMN) exists as a solution in the corresponding serving entry of the RLF DB. In some cases, the solution information may need to pass one or more tests, such as service has been acquired, SIBs (e.g., MIB, SIB1 and SIB2) have been successfully read, it has passed the cell barring check, time in OOS does not pass the upper bound (e.g., 5 minutes). If these conditions are met, Time_in_OOS, Success_Count, and Last_Success elements may be updated.

RLF DB entries may be removed based on one or more conditions. For example, the last entry of an RLF DB may be removed whenever a new entry should be added and the list is at its maximum length. The last entry may be defined as an entry with the lowest “Sort_score” which provides some indication of the value of the information stored therein. The Sort_score may be defined, for example, as:

Sort_score=Occurrence_Count/(Time since Last_Occurrence)+1/NΣSuccess_Count/(Time since Last_Success)

where N is the number of elements in the solution table. The last entry in the solution list of a RLF DB entry may be removed whenever a new entry should be added to the solution table and the list is at its maximum length. The last entry is the entry with a lowest Solution_score, which may provide an indication of the effectiveness of the solution (e.g., how successful, how often). The Solution_score may be defined as:

Solution_score=Success_Count/(Time since Last_Success)

As described above, aspects of the present disclosure provide techniques that may help enhance UE scanning procedures when looking for service, for example, after a loss of service event.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As used herein, a phrase referring to “at least one of” a list of items refers to any combination of those items, including single members. As an example, “at least one of: a, b, or c” is intended to cover: a, b, c, a-b, a-c, b-c, and a-b-c.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communication by an apparatus, comprising:
detecting a loss in service in a first cell;
performing a band scan of bands supported by the apparatus to attempt to acquire service; and
interleaving, based on a predetermined time period or a number of bands scanned during the band scan, a priority-based scan of a limited number of one or more frequencies while performing the band scan.

2. The method of claim 1, further comprising performing a priority-based scan of one or more frequencies from at least one of an acquisition database (Acq DB) or a list of advertised neighbors to attempt to acquire service prior to performing the band scan.

3. The method of claim 2, wherein the Acq DB includes E-UTRA Absolute Radio Frequency Channel Number (EARFCN) values for one or more cells previously camped on by the apparatus.

4. The method of claim 1, wherein interleaving, based on a predetermined time period or a number of bands scanned during the band scan, a priority-based scan of a limited number of one or more frequencies while performing the band scan comprises:
performing a priority-based scan of one or more frequencies from at least one of an acquisition database (Acq DB) at regular time intervals during the band scan.

5. The method of claim 1, wherein interleaving, based on a predetermined time period or a number of bands scanned during the band scan, a priority-based scan of a limited number of one or more frequencies while performing the band scan comprises:
alternating between performing a band scan and performing a priority-based scan of one or more frequencies from at least one of an acquisition database (Acq DB).

6. The method of claim 1, wherein interleaving, based on a predetermined time period or a number of bands scanned during the band scan, a priority-based scan of a limited number of one or more frequencies while performing the band scan comprises:
performing a priority-based scan of a band corresponding to the first cell in which service was lost at regular time intervals during the band scan.

7. The method of claim 6, wherein the regular time intervals correspond to a period of an integer value of a band scan interval.

8. A method for wireless communication by an apparatus, comprising:
storing information related to one or more loss of service events;
detecting a loss in service in a first cell; and
performing a priority-based scan of one or more frequencies, determined using the stored information, to attempt to acquire service.

9. The method of claim 8, further comprising:
determining, based on the stored information, that the loss in service is similar to a previous loss of service event; and
performing the priority-based scan based on stored information from the previous loss of service event.

10. The method of claim 8, wherein the information is stored in a database with entries identified by one or more parameters that identify a cell where a loss of service event occurred.

11. The method of claim 10, wherein the one or more parameters comprise an E-UTRA Absolute Radio Frequency Channel Number (EARFCN), public land mobile network (PLMN) identifier (ID), and a physical cell ID (PCI).

12. The method of claim 11, further comprising identifying an entry for a previous loss of service event on the first cell, based on the EARFCN, PLMN ID, and PCI of the first cell.

13. The method of claim 10, wherein each entry for a cell includes information regarding at least one of a frequency at which a loss of service event occurred, a number of times the loss of service event occurred, apparatus mobility information, or a time of a last occurrence of the loss of service event.

14. The method of claim 10, wherein each entry for a cell includes information regarding a second cell on which service was acquired following the loss of service event.

15. The method of claim 14, wherein the information regarding a second cell on which service was acquired following the loss of service event comprises:
an E-UTRA Absolute Radio Frequency Channel Number (EARFCN), public land mobile network (PLMN) identifier (ID), and a physical cell ID (PCI) of the cell on which service was acquired following the loss of service event.

16. The method of claim 14, wherein each entry for a cell includes at least one of:
time spent after the loss of service occurred before acquiring service on the second cell or a success rate for acquiring service on the second cell.

17. The method of claim 10, further comprising creating an entry in the database for a cell that does not have a matching entry.

18. The method of claim 17, further comprising removing an entry from the database if a number or entries is at a threshold value.

19. The method of claim 18, wherein removing an entry from the database includes removing an entry from the database based on at least one of: a time since a last occurrence of a loss of service, a number of occurrences of loss of service, a number of times service was successfully acquired after performing a priority-based scan using parameters in the entry, or time since a service was last successfully acquired after performing a priority-based scan using parameters in the entry.

20. The method of claim 10, further comprising updating an entry in the database for a cell if the apparatus detects a loss of service on that cell.

21. The method of claim 20, wherein updating the entry comprises at least one of:
updating at least one of an occurrence count, a time since a last occurrence of a loss of service event, a number of times service was successfully acquired after performing a priority-based scan using parameters in the entry, or time since a service was last successfully acquired after performing a priority-based scan using parameters in the entry;
removing parameters for a cell on which service was successfully acquired after a loss of service event; or
adding parameters for a cell on which service was successfully acquired after a loss of service.

22. The method of claim 8, further comprising storing information related to at least one of solution employed in response to the one or more loss of service events or patterns of apparatus movement.

23. The method of claim 8, wherein the stored information is maintained by the apparatus.

24. An apparatus for wireless communications by a user equipment (UE), comprising:
means for detecting a loss in service in a first cell;
means for performing a band scan of bands supported by the apparatus to attempt to acquire service; and
means for interleaving, based on a predetermined time period or a number of bands scanned during the band scan, a priority-based scan of a limited number of one or more frequencies while performing the band scan.

25. An apparatus for wireless communications by a user equipment (UE), comprising:
means for storing information related to one or more loss of service events;
means for detecting a loss in service in a first cell; and
means for performing a priority-based scan of one or more frequencies, determined using the stored information, to attempt to acquire service.

26. The apparatus of claim 25, wherein the information is stored in a database with entries identified by one or more parameters that identify a cell where a loss of service event occurred.

27. The apparatus of claim 26, wherein each entry for a cell includes information regarding at least one of a frequency at which a loss of service event occurred, a number of times the loss of service event occurred, apparatus mobility information, or a time of a last occurrence of the loss of service event.

28. The apparatus of claim 26, wherein each entry for a cell includes information regarding a second cell on which service was acquired following the loss of service event.

29. The apparatus of claim 25, further comprising means for storing information related to at least one of solution employed in response to the one or more loss of service events or patterns of apparatus movement.

30. The apparatus of claim 25, further comprising means for maintaining the information stored by the apparatus.
